(19) United States
(12) Patent Application Publication
(10) Pub. No.: US 2003/0115132 A1
(43) Pub. Date: Jun. 19, 2003

(54) Method for virtual trading

(76) Inventor: Benny Ingemar Iggland, Zurich (CH)

Correspondence Address: Orum & Roth, 53 West Jackson Boulevard, Chicago, IL, 60604-3606, US

(21) Appl. No.: 10/312,118

(22) PCT Filed: Jul. 16, 2001
(86) PCT No.: PCT/SE01/01628

(30) Foreign Application Priority Data
Jul. 17, 2000 (SE) 0002581-7

(51) Int. Cl. G06F 17/60

(52) U.S. Cl. 705/37

(57) ABSTRACT

The invention relates to a system so arranged as to be capable of being used over the Internet. People from all over the world have the opportunity, via their computers, which are connected to the Internet, to enter a created data world/universe (E). Once they have entered the virtual world/universe, they can interact with other people or computer-generated “avatars”/figures or things. The unique feature of the invention is a financial system in which users (A) of the system can be stored digitally and can be utilized in a non-physical world/universe, i.e. a virtual world/universe. The converse of what is described above is also true, namely that users (A) can sell virtual things or services (K), which only exist in electronic or virtual form, or which can be stored digitally and can be utilized in a non-physical world/universe (D) in return for a consideration in real money (P).

The present invention relates to a system for a computer in conjunction with use of the Internet, in which a created virtual data world or universe is formed, in which users of the system are connected to the Internet via their computers to provide data access in such a way that users, once they have accessed the system, are enabled to interact with other users, and users of the system are enabled to access the aforementioned virtual data world, etc., in the form of so-called avatars or three-dimensional figures.

Previously disclosed games intended for computers, for example via the Internet or some other similar global communications network, lack the facility of being able to purchase for real money various aids, features or other things that can be used in the aforementioned games in order to progress further in the game and thus also in the opposite direction, i.e. the facility of being able to sell equivalent things and receive real money for such things and features.

The principal object of the present invention is thus, in the first instance, to solve the aforementioned problems by simple and efficiently functioning means.

The aforementioned object is achieved by means of a system in accordance with the present invention, which is characterized essentially in that users of the system are enabled to purchase and/or sell virtual things and/or services, which only exist in the system in electronic or virtual form, or are stored digitally, and which users of the system can utilize in an aforementioned created virtual Internet-based data world, etc., in that goods, buildings, companies and devices which are constructed, purchased and sold, exist only in electronic form, for example in the form of a graphical file which describes the goods visually, in that services that are performed in return for a financial consideration are so arranged as to exist only in electronic form, such as helping a virtual “figure”, which is controlled by another physical user, to find its way to a specific location in the virtual world, in that skills and abilities that have been acquired in the physical world, and from which financial advantage can be derived, are so arranged, through work and/or financial input, as to be capable of being transformed into their equivalent in the virtual world, in conjunction with which payment is so arranged as to take place with the help of real money.

The invention is described below as a number of preferred illustrative embodiments, in conjunction with which reference is made to the accompanying drawings, where:

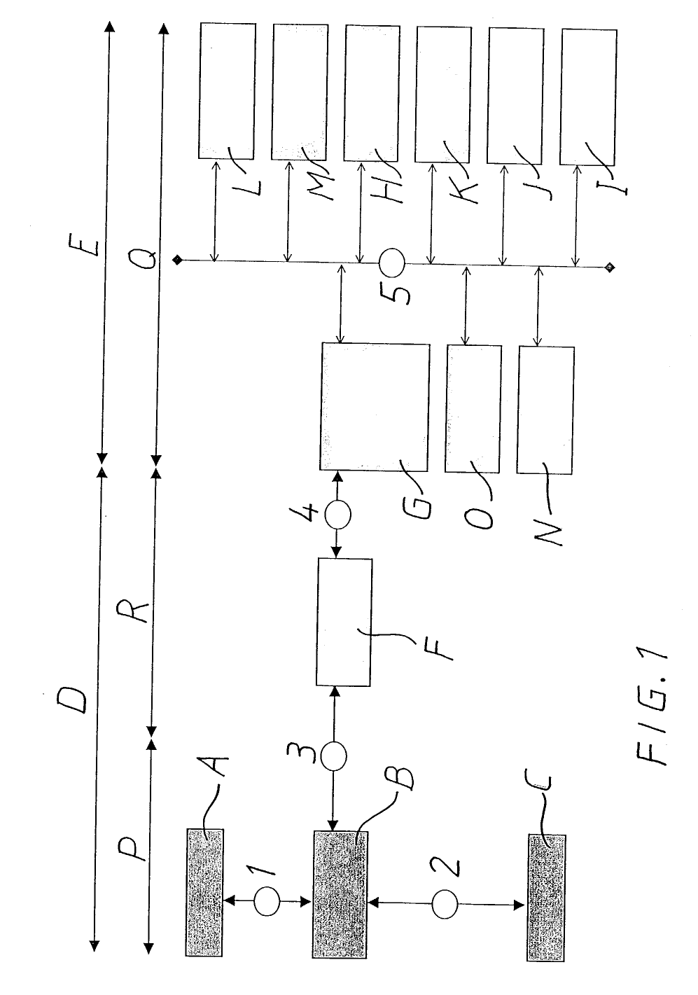

FIG. 1 shows a block diagram of the entire system;

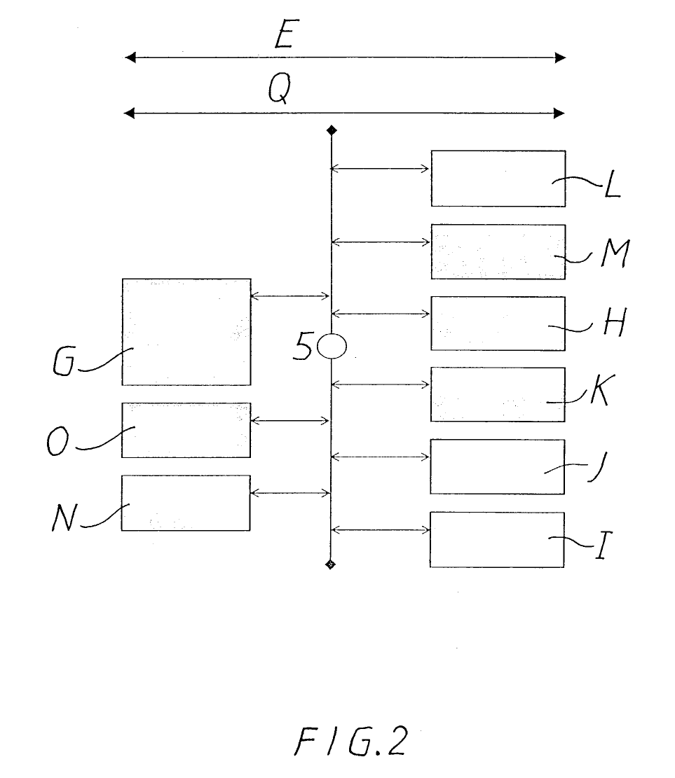

FIG. 2 shows part of the system as a clear block diagram with the virtual part thereof illustrated; and

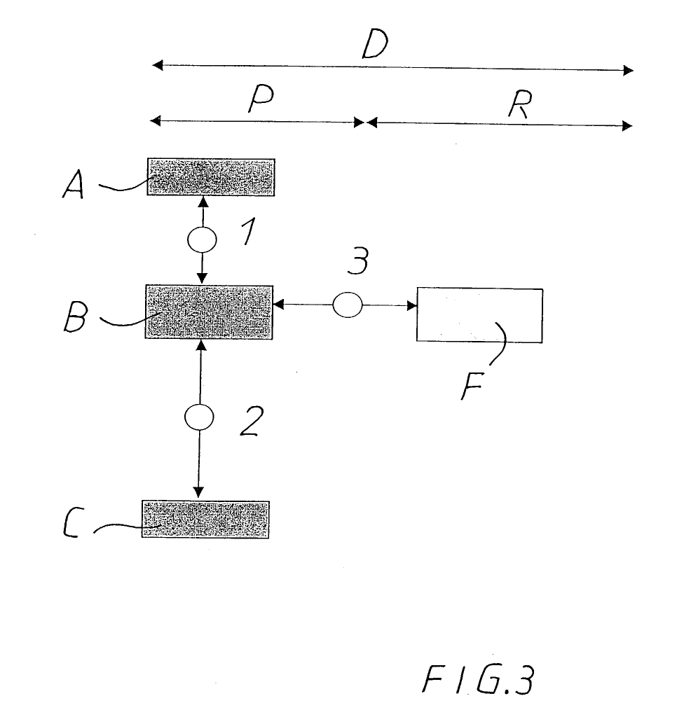

FIG. 3 shows the remaining part of the system in the form of a block diagram.

An Internet-based virtual world and/or a universe is created by means of the present computer system. People all over the world have the opportunity, via their computers, once they are connected to the Internet or similar, to enter the created world/universe of the present invention in the form of a number of avatars which form three-dimensional figures of varying kinds. Once they have entered the aforementioned virtual world and/or the aforementioned virtual universe, they can then interact with other people or computer-generated avatars in the form of figures or things which the users of the computer system utilize.

The novel and most unique feature of the present invention is the inclusion of a financial system in the actual computer system. More specifically, the system is so arranged that users of the system are enabled, with the help of real money, to purchase and/or sell virtual things and/or services which only exist in the system in electronic or virtual form, or which are so arranged as to be capable of being stored digitally, and which users of the system in question can utilize in the aforementioned virtual world/universe (non-physical world/universe). The converse of what is stated above is also true, namely that a person (a user of the system) can sell virtual things or services, which only exist in electronic or virtual form, or which can be stored digitally and can be used in a non-physical world/universe (a virtual world/universe), in return for a consideration in real money (a convertible currency).

The aforementioned financial element of the system also includes remunerations and/or prices for performances executed in the aforementioned virtual data world.

The drawings in FIGS. 1, 2 and 3 show how payment for the virtual things and/or services in question is so arranged as to take place by means of a credit card payment and/or by means of a micropayment system, in which use is made of the user's existing payment intermediary, for example telecommunications operators, energy companies, grocery chains or petrol companies.

The reference designations 1 and 2 in FIGS. 1 and 3 are used to indicate existing channels and methods for the purchase and sale of goods and services via the Internet. This can thus take place in the traditional way via credit companies. It can thus also take place with the help of systems for micropayment, which are now in the process of becoming established and have been available since 1999. A characteristic feature of these systems is that they permit customer A and the seller to use an existing payment intermediary (IPP) B, by whom the customer A is invoiced monthly, for the subsequent transfer of payment to recipient C or seller A.

FIG. 1 contains the numbers 3 and 4, which designate the communications interface between the physical world and the virtual world, respectively D and E.

In order to be able to administer and keep track of the financial transactions and the status of customers A and users in the virtual world E, use is made of a server-based accounting system F, which also exists in the physical world D.

This server-based accounting system F functions and is executed as follows:

A computer-based system which, in all essential respects, resembles the accounting systems in use in the banks in the physical world.

Communicates with the accounting system in the bank G in the virtual world.

Handles all communication to and from the payment intermediary in the real world, for both deposits and withdrawals in convertible currency.

Handles all encryption and security for both external and internal communication.

Illustrated in FIG. 2 and designated by the number 5 are the rules and channels of the virtual world for trade, the exchange of goods, the exchange of services, competitions, combats and other activities which can be linked to a financial transaction in accordance with the invention.

The financial system in the virtual world differs from that of the real world in various respects:

Goods H, buildings I, companies and devices J, which are constructed, purchased and sold, exist only in electronic form. This can be in the form of a graphics file, for example, which describes the goods visually.

Services K, which are performed in return for a financial consideration, similarly exist only in electronic form. This can involve, for example, helping a virtual “figure” L, which is controlled by another physical user, to find its way to a specific location in the virtual world (a so-called avatar).

Skills and abilities that have been acquired in the physical world D, and from which it is possible to derive financial benefit, cannot be transformed immediately, and without work and/or financial input, into their equivalent in the virtual world E.

The letters M, N and O are also used to designate computer-controlled figures, a virtual share market and remunerations and prices, P and Q respectively denote actual money and virtual money, and R denotes the transaction interface between real and unreal virtual computer money. The expression money shall be understood to denote means of payment in some form, even if you do not receive cash in hand, without their being transferred, for example electronically, to the owner's account.

It is possible to interpret the invention, for example, as involving games and similar activities via the computer, where the challenge is a matter of solving different problems, fighting different objects, competing, buying and selling, etc. The invention is not restricted to what is described and illustrated above, but may be varied within the scope of the Patent Claims without departing from the idea of invention.

1. System for a computer in conjunction with use of the Internet, in which a created virtual data world or universe (E) is formed, in which users of the system are connected to the Internet via their computers to provide data access in such a way that users, once they have accessed the system, are enabled to interact with other users, and that users (A) of the system are enabled to access the aforementioned virtual data world, etc. (E), in the form of so-called avatars or three dimensional figures (L), characterized in that the system which is a game contains communication interface between the physical world and the virtual world, respectively (D and E), in that users of the game enter via their computers to a created world/universe in the form of a number of avatars, in that use is made of a server-based accounting system in order to be able to administer and keep track of the financial transactions and the status of the user in the virtual world, in that the server-based accounting system (F) functions and is executed as follows;
the computer-based system which in all essential respects, resembles the accounting systems in use in the banks in the physical world, communicates with the accounting system in the bank (G) in the virtual world, it handles all communication to and from the payment intermediary in the real world, for both deposits and withdrawals in convertible currency, and it handles all encryption and security for both external and internal communication, users (A) of the system are enabled to purchase and/or sell virtual things and/or services, which only exist in the system in electronic or virtual form, or are stored digitally, and which users of the system can utilize in an aforementioned created virtual Internet-based data world, etc., in that goods (H), buildings (I), companies and devices (J) which are constructed, purchased and sold exist only in electronic form, for example in the form of a graphical file which describes the goods visually, in that services (K) that are performed in return for a financial consideration are so arranged as to exist only in electronic form, such as helping a virtual “figure”, which is controlled by another physical user, to find its way to a specific location in the virtual world, and in that skills and abilities that have been acquired in the physical world (D), and from which financial advantage can be derived, are so arranged, through work and/or financial input, as to be capable of being transformed into their equivalent in the virtual world (E), in conjunction with which payment is so arranged as to take place with the help of real money (P).

2. System in accordance with Patent claim 1, characterized in that the financial element of the system also includes remunerations and/or prices (O) for performances executed in the aforementioned virtual data world (E).

3. System in accordance with one or other of the above Patent Claims, characterized in that payment for the virtual things and/or services in question is so arranged as to take place by means of credit card payment and/or by means of a micropayment system, in which use is made of the user's existing payment intermediary, for example telecommunications operators, energy companies or petrol companies.

4. System in accordance with one or other of the above Patent Claims, characterized in that the aforementioned server-based accounting system is so arranged as to communicate with an accounting system in the bank (G) in the virtual world.

5. System in accordance with one or other of the above Patent Claims, characterized in that the aforementioned server-based accounting system (F) is so arranged as to handle all communication to and from the payment intermediary in the real world, for both deposits and withdrawals in convertible currency.

6. System in accordance with one or other of the above Patent Claims, characterized in that the aforementioned server-based accounting system is so arranged as to handle encryption and security for both external and internal communication.
